(19) United States
(12) Patent Application Publication
(10) Pub. No.: US 2018/0077105 A1
(43) Pub. Date: Mar. 15, 2018

(54) METHOD AND SYSTEM FOR ON DEMAND FABRICATION OF SOCIAL NETWORK MESSAGES

(71) Applicant: Making DeGraide Technology, LLC, Orlando, FL (US)

(72) Inventor: Adam D. DeGraide, Orlando, FL (US)

(73) Assignee: Making DeGraide Technology, LLC, Orlando, FL (US)

(21) Appl. No.: 15/353,145

(22) Filed: Nov. 16, 2016

Related U.S. Application Data
(60) Provisional application No. 62/394,834, filed on Sep. 15, 2016.

(51) Int. Cl. H04L 12/58

(52) U.S. Cl. CPC H04L 51/32; H04L 51/063

(57) ABSTRACT

A method and system for on demand fabrication of social network marketing messages is disclosed. The method and system includes a computational device having one or more libraries containing a plurality of messages and a plurality of images, categorized according to topic. Messages and images are selected from the libraries by a content selection module and image selection module that minimize frequency of use of the selected content. A message fabrication module creates a social network message from content and image selected by the content selection module and image selection module, respectively. The message fabrication module is further configured to ensure only a compatible image and a compatible message is used to create the social network message. A delivery module transmits the fabricated social network message to a pre-designated social network for publication.

### CROSS-REFERENCE TO RELATED APPLICATION

This patent document claims priority to earlier filed U.S. Provisional Patent Application No. 62/394,834, filed on Sep. 15, 2016, the entire contents of which are incorporated herein by reference.

### BACKGROUND

### 1. Technical Field

This patent document relates generally social media marketing and more particularly to a method and system for on demand fabrication of deliverable social network messages from human curated content and image libraries.

### 2. Background of the Related Art

Social networks, such as Instagram, Facebook, Twitter, Pinterest and the like, have become an integral part of any modern marketing strategy. It is of particular importance that marketing content includes images and text, yet remain relevant with the targeted market. Because the message from any particular industry remains somewhat static and the development costs of curating text and images for content may be high, the development of social network messages that remain fresh and new to the targeted market is desirable in order to increase

Therefore, there is a perceived need in the industry for a method and system for improving the relevancy of social network messages by keeping them fresh and new, yet conserves resources in developing marketing content.

### SUMMARY

The method and system described herein solves the problems of the prior art by providing a system for on demand fabrication of social network messages that includes a computational device having a content library containing a plurality of messages and an image library containing a plurality of images. The messages and images are further categorized according to topic. The system and method further includes a content selection module that selects messages from the content library, minimizing frequency of use. Further included, is an image selection module that selects images from the image library, minimizing frequency of use. A message fabrication module creates a social network message from content selected by the content selection module and image selection module. The message fabrication module is further configured to ensure only a compatible image and a compatible message is used to create the social network message. A delivery module transmits the fabricated social network message to a pre-designated social network for publication.

Among the objects of the system and method is the provision for a method and system that minimizes the reuse of content and images in social network message.

Another object of the method and system is the provision of a method and system that conserves marketing resources through selective reuse of content and images.

Another object of the method and system is the provision of a method and system that creates fresh social network messages through new combinations of content and images from curated libraries of content and images.

Another object of the method and system is the provision of a method and system that creates social network messages on demand.

Another object of the method and system is the provision of a method and system that creates social network messages from curated content.

Another object of the method and system is the provision of a method and system that creates social network messages where the images and messages selected have synergy.

### BRIEF DESCRIPTION OF THE DRAWINGS

These and other features, aspects, and advantages of the present invention will become better understood with reference to the following description, appended claims, and accompanying drawings where:

FIG. 1 shows a diagram of an embodiment of the method and system for on demand fabrication of deliverable social network messages;

FIG. 2 shows a flow chart of the steps of an embodiment of the method and system for on demand fabrication of deliverable social network messages; and

FIG. 3 shows an illustration of an embodiment of the method and system for on demand fabrication of deliverable social network messages.

### DESCRIPTION OF THE PREFERRED EMBODIMENT

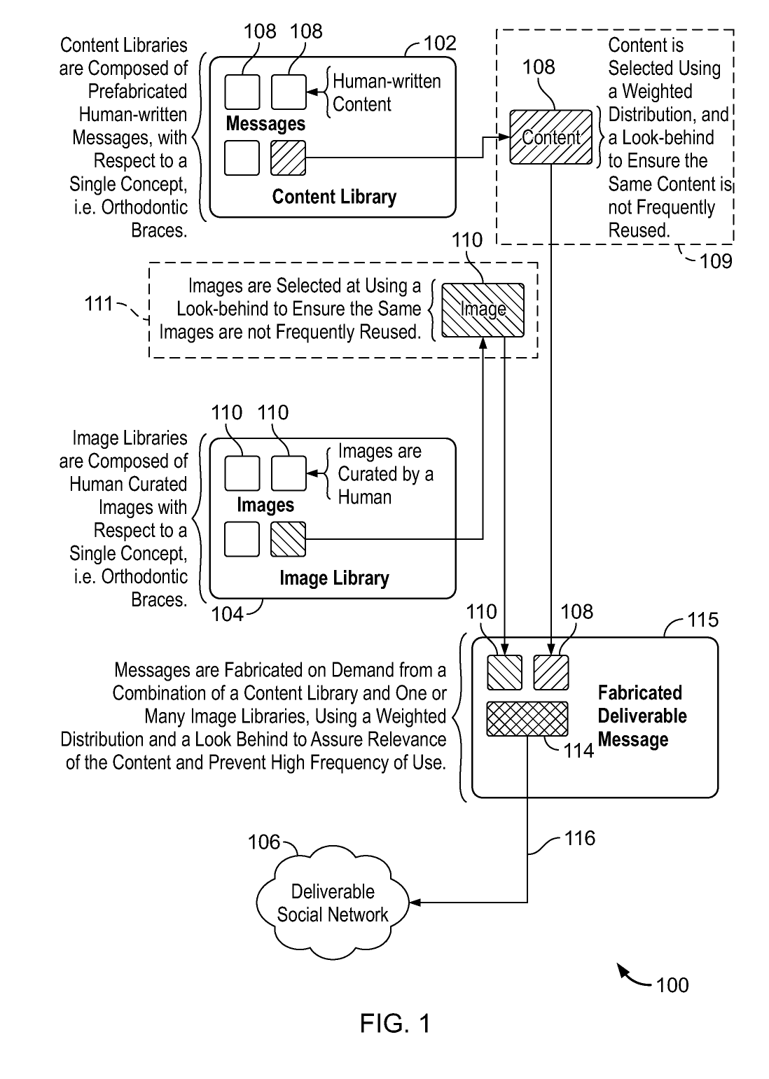

Referring now to FIG. 1, an embodiment of the method and system is shown generally at 100. As will be described in greater detail below, the method and system 100 includes a computational device 300 having one or more libraries 102, 104 containing a plurality of messages 108 and a plurality of images 110, categorized according to topic. Messages 108 and images 110 are selected from the libraries 102, 104 by a content selection module 109 and image selection module III that minimize frequency of use of the selected content. A message fabrication module 115 creates a social network message 114 from content 108 and image 110 selected by the content selection module 109 and image selection module III, respectively. The message fabrication module 115 is further configured to ensure only a compatible image 110 and a compatible message 108 is used to create the social network message 114.

A delivery module transmits 116 the fabricated social network message 114 to a pre-designated social network 106 for publication.

The method and system 100 includes one or more content libraries 102. Content libraries include prefabricated human-written messages 108, directed to or categorized in a single concept or topic. For example, a content library 102 could include messages 108 directed to promoting orthodontic braces. The content library 102 may include log entries directed to the use or frequency of use of any particular message 108. Each message 108 stored in the content library may include a plurality of keywords, tags, or other associated descriptors to categorize the message. A content selection module 109 selects messages 108 using weighted distribution method, and a look-up to ensure the same content is not used recently or overly used in the past.

The method and system 100 further includes one or more image libraries 104. Image libraries 104 include human-curated images 110, directed to or categorized in a single concept or topic. For example, an image library 104 could include images 104 directed to promoting orthodontic braces. The image library 104 may include log entries directed to the use or frequency of use of any particular image. Each image 110 stored in the image library 104 may include a plurality of keywords, tags, or other associated descriptors to aid further in categorize the image 110. An image selection module III selects images 110 using weighted distribution method, and a look-up to ensure the same content is not used recently or overly used in the past.

A message fabrication module 115 assembles a social network message 114, on demand, from a combination of at least one message 108 from the content library 102 and at least one image 110 from the image library 104, selected by the content selection module 109 and image selection module III, respectively. The message fabrication module 115 will further compare the keywords, tags, and/or other associated descriptors of the selected image with the keywords, tags, and/or other associated descriptors of the selected message to ensure a compatible and/or relevant match between the selected image 108 and the selected message 110. Furthermore, the message fabrication module 115 will prevent a high frequency of use or any particular message 108 or image 110 selected.

A delivery module 116 transmits the fabricated social network message 114 to the associated social network 106.

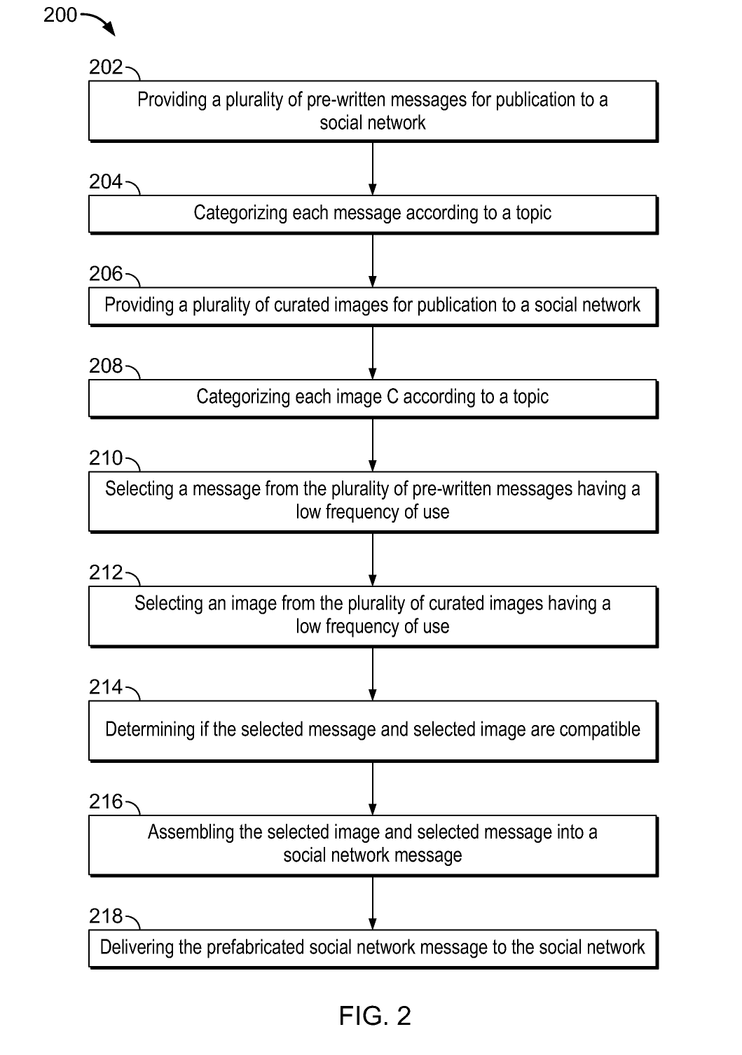

Referring to FIG. 2, the method and system for on demand fabrication of social network marketing messages, as described above in relation to FIG. 1, is shown illustrated as a series of steps at 200, in a first step 202, a plurality of pre-written messages for publication to a social network is provided. The messages are categorized according to a topic at step 204. Also provided in a step 206, are a plurality of curated images for publication to the social network. These images are also categorized according to a topic in a step 208. In a next step 210, a message from the plurality of pre-written messages having a low frequency of use is selected. In a next step 212, an image from the plurality of curated images having a low frequency of use is selected. In a next step 214, whether the selected message and selected image are compatible is determined. In a next step 216, the selected image and selected message are assembled into a social network message. In a next step 218, the prefabricated social network message is delivered to the social network.

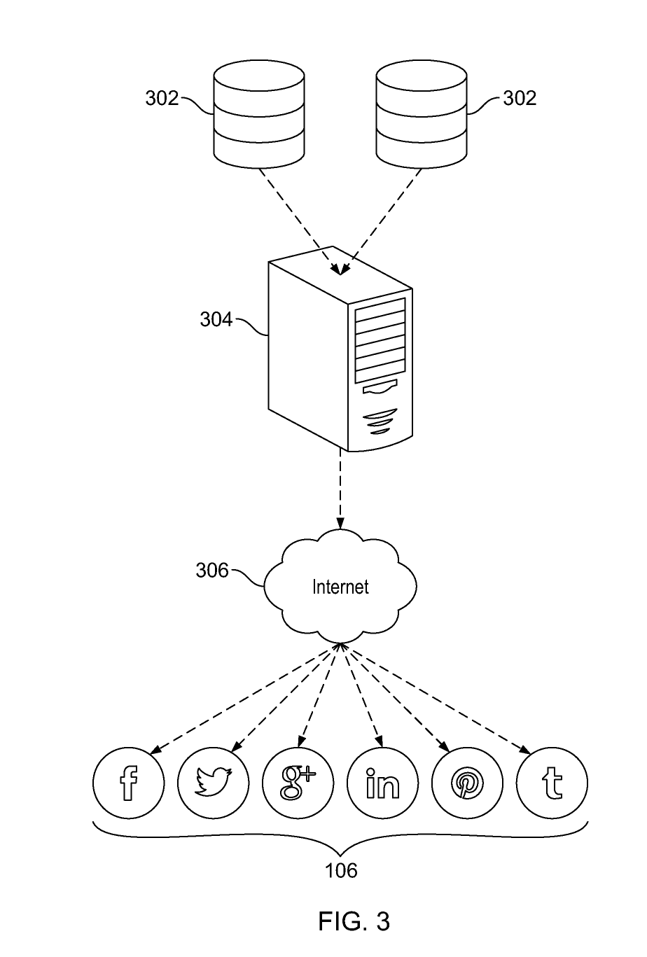

Referring to FIG. 3, the system 100 may be any arrangement known in the art that offers online computational functionality, including but not limited to a server or server arrangement 300, the Internet “cloud” 304, or other computational devices. The functionality called for herein in the aforementioned modules and steps may be executed over multiple devices forming the system and is not limited to a single device. Suitable computational devices, such as server 300, typically include a processor, memory and storage, where the storage may be solid-state device or a hard disc. The computational devices also include a communication device, including a transmitter and receiver functionality configured to communicate with other computational devices in a network arrangement. The communication device may be wired or wireless, as is known in the art.

The system may call of the computational device to establish and maintain a specialized database or a specialized collection of databases 302. The database 302 may be configured to store the content libraries, image libraries, the keywords, tags and/or associated descriptors and use logs of the content and images of the respective libraries, properties and factors for the weighted distribution filter, and designated social networks to received deliverable social network messages fabricated by the system and method.

Therefore the method and system provides a process for fabricating social network marketing content messages that vary the frequency of use of curated-images and industry-directed messages that maintains the freshness of the social network messages yet reduces costs of development and conserves marketing efforts in developing new messages and images. Further, because the fabrication module ensures compatibility between the selected image and selected message, therefore, having a synergy, the resulting fabricated social network message is higher impact on the target consumer or viewer.

It would be appreciated by those skilled in the art that various changes and modifications can be made to the illustrated embodiments without departing from the spirit of the present invention. All such modifications and changes are intended to be within the scope of the present invention.

What is claimed is:

1. A system for on demand fabrication of social network messages, comprising:
a computational device comprising:
a content library containing a plurality of messages;
an image library containing a plurality of images;
a content selection module configured to select messages from the content library;
an image selection module configured to select images from the image library; and
a message fabrication module configured to create a social network message from content selected by the content selection module and image selection module.

2. The system of claim 1, wherein the messages are categorized within the content library according to topic.

3. The system of claim 1, wherein the messages have a plurality of keywords, tags and associated descriptors.

4. The system of claim 1, the images categorized within the image library according to topic.

5. The system of claim 1, wherein the images have a plurality of keywords, tags and associated descriptors.

6. The system of claim 1, wherein the message fabrication module is further configured to ensure only a compatible image and a compatible message are used to create the social network message

7. The system of claim 1, wherein the content selection module is further configured and arranged to minimize frequency of use of a message.

8. The system of claim 1, wherein the image selection module is further configured and arranged to minimize the frequency of use of an image.

9. The system of claim 1, further comprising a delivery module configured to transmit the fabricated social network message to a pre-designated social network for publication

10. The system of claim 1, further comprising log entries of prior use of each message and each image.

11. The system of claim 1, wherein the content selection module uses a weighted distribution factor to select the message.

12. The system of claim 1, wherein the content selection module reviews prior use of the message prior to selection of the message.

13. The system of claim 1, wherein the image selection module uses a weighted distribution factor to select the image.

14. The system of claim 1, wherein the content selection module reviews prior use of the image prior to selection of the image.

15. A method for on demand fabrication of social network messages, comprising:
providing a plurality of pre-written messages for publication to a social network;
providing a plurality of curated images for publication to a social network;
selecting a message from the plurality of pre-written messages;
selecting an image from the plurality of curated images; and
assembling the selected image and selected message into a social network message.

16. The method of claim 15, further comprising categorizing each message according to a topic.

17. The method of claim 15, further comprising categorizing each image c according to a topic.

18. The method of claim 15, further comprising delivering the prefabricated social network message to the social network.

19. The method of claim 15, further comprising selecting a message having a low frequency of use.

20. The method of claim 16, further comprising selecting an image having a low frequency of use.
